(19) United States
(12) Patent Application Publication
(10) Pub. No.: US 2009/0287417 A1
(43) Pub. Date: Nov. 19, 2009

(54) Method for Detecting a Biochemical Interaction

(76) Inventor: Kaupo Palo, Harju (EE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/990,957

(22) PCT Filed: Aug. 29, 2006
(86) PCT No.: PCT/EP2006/065771

§ 371 Date: Feb. 25, 2008

(30) Foreign Application Priority Data
Aug. 30, 2005 (EP) 05107912.7

(51) Int. Cl. G06F 19/00; G06F 17/10; G06F 17/18

(52) U.S. Cl. 702/19; 703/2; 702/179

(57) ABSTRACT

A method for detecting a biochemical interaction between at least two interaction partners, comprising the steps of bringing into contact the at least two interaction partners, taking a temporal sequence of measurements, each of them producing a measurement value describing the state of the interaction at a given point in time, adapting a mathematical model to the temporal sequence of measurements, whereby the model contains at least one first parameter characterising a temporal phase of increasing measurement values and at least one second parameter characterising a temporal phase of decreasing measurement values, and detecting the biochemical interaction by evaluating the first and second parameter.

### BACKGROUND

1. Field of the Disclosure

The disclosure relates to a method for detecting a biochemical interaction between at least two interaction partners.

2. Discussion of the Background Art

For detecting the interaction of two biochemical partners, it is e.g. known to monitor the fluorescence change (counts) of various samples over the time. To generate a fluorescent signal, it is e.g. known to dispense as one interaction partner a potential agonist to cell-based samples, a receptor present in the cells being the second interaction partner. To perform a large number of tests, the interaction partners are e.g. dispensed into wells of a microtiter plate. These microtiter plates, having e.g. 96, 384 or 1536 wells which are commonly used to carry a variety of first interaction partners and identical second interaction partners, are analysed in high- or medium-throughput screening-devices. The reaction of the interaction partners and the presence of a fluorescent dye leads to a fluorescence signal for each well, whereby the intensity of the signal changes over time. To decide whether the interaction partners of one well are of interest, the maximum peak height (PH) of the fluorescence response signal or the area under the curve (AUC) of the response signal during a given time period is analysed. The problem of these parameters is that neither the area under the curve, nor the peak height of the response signal can distinguish between compound artefacts and relevant agonist responses. The artefacts can e.g. be caused by fluorescent compounds. In addition, it is not generally possible to distinguish agonists interacting specifically with the receptor under study from substances interacting unspecifically with a multitude of cellular receptors.

Therefore, in order to decide whether a potential agonist (hit) is of further interest or not, it is necessary according to the state of the art to perform a confirmation screen, typically using identical concentrations and conditions of the first interaction partners. Subsequent steps frequently include a selectivity screen, using e.g. the interaction with a different receptor or a receptor isoform, and/or a parental screen with a receptor negative cell line for comparison. Also, a validation screen using different concentrations of the first interaction partner may be performed to establish dose response relationships. During each step of this method the hits are further characterized. The goal here is to remove those hits that have undesirable properties and to concentrate on those hits which pass the selection criteria. It is quite common that at one or more steps during this method chemists select a subset of hits that will be taken to the next step based on the presumed likelihood that a hit can be converted into a molecule with drug like properties. The entire method is e.g. described in: A. D. Baxter and P. M. Lockley, “‘Hit’ to ‘lead’ and ‘lead’ to ‘candidate’ optimisation using multi-parametric principles”, Drug Disc. World Winter 2001/2.

Since it is necessary to perform these additional screens, the known method is expensive and time-consuming. It is an object of the disclosure to improve the method for detecting a biochemical interaction, whereby the analysis of the derived data shall be improved leading to a better prediction of chemically attractive compounds for follow-up studies.

### SUMMARY OF THE DISCLOSURE

A method for detecting a biochemical interaction between at least two interaction partners comprises the following steps:
bringing into contact the at least two interaction partners,
taking a temporal sequence of measurements, each of them producing a measurement value describing the state of the interaction at a given point in time,
choosing a mathematical model to describe the temporal sequence of measurements, whereby the model comprises at least one first parameter characterising a temporal phase of increasing measurement values and at least one second parameter characterising a temporal phase of decreasing measurement values,
adapting the mathematical model to the temporal sequence of measurements, whereby values for said parameters are determined which result in a good approximation of the temporal sequence of measurements by the mathematical model, and
detecting the biochemical interaction by evaluating the first and second parameter and/or a measure of deviation of the mathematical model from the temporal sequence of measurements.

Since according to the disclosure a mathematical model, e.g. a mathematical describable curve, is adapted to the temporal sequence of measurements, a first and second parameter can be determined. These parameters can be used to decide whether the substances within a well are of interest or not. Within a preferred embodiment using specific relevant parameters of the mathematical model, it may not be necessary to perform an additional confirmation, parental, selectivity and/or validation screen. Thus, the information of interest can be derived quicker. Additionally, the screening costs can be decreased further, by saving costs for labour chemical compounds and reagents required to carry out those secondary screens.

The interaction partners that are brought together in the first step, are e.g. small organic molecules (chemical compounds), proteins, peptides, polynucleotide strands, natural cellular receptors or target receptors of interest expressed heterologously in a cell line. The performed measurement is e.g. the measurement of the fluorescence intensity over the time. To provide for a fluorescent read-out, typically a fluorescent dye is also added to the sample comprising the two interaction partners. Depending on the biochemical reaction to be studied, this may be an ion sensitive dye (e.g. a calcium sensitive dye), a potential sensitive dye or a pH sensitive dye. Specifically, dyes of the bis-barbituric acid oxonol type may be used such as Dibac₄(3) DiSBAC₂(3) or DiBAC₄(5) which are commercially available (e.g. by the supplier Molecular Probes). Also other oxonol dyes such as bis-isoxazolone oxonol dyes (e.g. Oxonol V and Oxonol VI) may be applied. Further voltage-sensitive indicators include carbocyanine derivatives (e.g. indo-, thia-, and oxa-carbocyanines as well as iodide derivatives of carbocyanines), rhodamine dyes, merocyanine 540 and styryl dyes. Among the styryl dyes, one might apply dyes of the aminonaphtylethenylpyridinium type such as di-4-ANEPPS, di-8-ANEPPS, di-2-ANEPEQ, di-8-ANEPPQ, di-12-ANEPPQ or di-1-ANEPIA which are all commercially available(Molecular Probes). Also RH-dyes of this or other suppliers may be used such as RH 414, RH 421, RH 795 or RH 237. As ion-sensitive indicators one might use well-known and commercially available calcium indicators (e.g. fluo-calcium indicators, fura indicators, indo indicators, Calcium Green™ or Oregon Green™; Molecular Probes) or sodium/potassium indicators (e.g. SBFI, PBFI, Sodium Green Na⁺ indicator, CoroNa Green Na⁺ indicator, CoroNa Red Na⁺ indicator; Molecular Probes).

The mathematical model or curve which is according to the disclosure preferably fitted to a part of the curve derived by the measurements, may be a straight line. In general, the curve derived by the measurements, has an increasing and a decreasing part or temporal sequence. The curve may either comprise an essentially increasing section, followed in time by an essentially decreasing section, or vice versa. Thus, in a first embodiment two straight lines can be fitted to the curve of the measurements.

Preferably, separate functions are used to describe the rise and decay of the sequence of measurements, e.g. to describe the increasing section and the decreasing section of the curve derived by the measurements. In a preferred embodiment, the mathematical models or curves fitted to the two sections of the measurement curve are segments of Gauss-functions, especially preferred half Gauss-functions. Either single Gaussian functions, or a superposition (i.e. a linear combination) of multiple segments of Gaussian functions can be used to fit each segment. Particularly, a superposition of two Gauss-curve segments is fitted to the decreasing section of the curve in one embodiment. It is also possible to divide the measured curve into more than two portions, whereby in each portion a mathematical model or curve is fitted to the measurement curve.

An additional advantage of the method according to the disclosure is that it is possible to store the parameters describing the mathematical models or curves instead of the raw measured data, whereby the data volume compared with the raw data is reduced. Particularly, the data volume is less than 20%, particularly less than 10% of the raw data.

The parameters of interest of the measurement curve and/or the fitted curve are the width (i.e. rise time) of the ascending curve, the width (i.e. decay time) of the descending curve, width of the descending curve squared as well as the Chi-squared, which is a measure for the consistency between measured curve and fitted curve known in the art. If more than two curves are fitted to the measurement curve, the width of each curve is of interest. In addition, the maximum and minimum height, the area under the curve, the mean height, the standard deviation of height, the amplitude and the position in time of the maximum can be obtained.

The mathematical models may be adapted via numerical least-squares fit. This approach, which is well known in the art, aims to minimise the mean square deviation between the measured data points and the mathematical model. Algorithms for carrying out the least squares fit for linear or non-linear mathematical models (e.g. Levenberg-Marquardt method) are known in the art (see e.g. W.H. Press at al., Numerical Recipes in C, Cambridge University Press, Cambridge 1992)

An important advantage of the method according to the disclosure is that within the last step, the detecting of the biochemical interaction by evaluating the first and second parameter, specific and non-specific interaction can be discriminated. Additionally, it is possible to discriminate between valid sequences of measurements and sequences of measurements influenced by measurements artefacts. The measurement artefacts may comprise auto fluorescence, and cytotoxic compounds.

According to a preferred embodiment of the disclosure, at least one interaction partner is a biochemical receptor. Preferably, one interaction partner is located in or on a cell, receptor, organic tissue, carrier particle consisting of organic or inorganic matter, carrier surface consisting of organic or inorganic matter or the like. The second interaction partner is preferably a chemical compound. One or both of the interaction partners may be dissolved or suspended in a liquid media or assay buffer.

Preferably, the interaction of a first interaction partner (e.g. a receptor) with a second interaction partner (e.g. a chemical compound) is investigated in high throughput experiments, and statistical analysis of the resulting multitude of model parameters is used in the detecting step.

### BRIEF DESCRIPTION OF THE DRAWINGS

A preferred embodiment of the method according to the disclosure will be described in detail on the basis of the enclosed figures:

FIG. 1 shows schematically two of the early steps of a method according to the state of the art.

FIG. 2 is a diagram of the peak height of fluorescence intensity traces obtained in a confirmation screen over the peak height of fluorescence intensity traces obtained in a selectivity screen.

FIG. 3 shows raw data as well as fit results of responses elicited by a positive control (left panel), a chemically attractive compound (centre panel) and an autofluorescent compound (right panel), respectively

FIG. 4 shows χ² values, quantifying the fit between measured data and mathematical models, for data obtained in a confirmation and a parental assay.

FIG. 5 shows χ² values, quantifying the fit between measured data and mathematical models, for data obtained in a confirmation assay. Shown are χ² values for all compound as well as those compounds that have been selected for the validation screen (IC₅₀ determination) and examples from the eight compound series.

FIG. 6 is a diagram of the normalized width of the ascending curve over the normalized width of the descending curve of fluorescence intensity traces obtained from all compounds tested in the confirmation screen. In addition, five representative example fluorescence intensity traces are shown.

FIG. 7 presents the same diagram as FIG. 6, showing only a subset of compounds. Blue labelled compounds are those that have been inactive in the parental screen and are therefore considered selective. Red labelled compounds are those that have also been active in the parental screen and are therefore considered non-selective. The green rectangle encompasses those compounds with kinetics that are within ˜10 fold of the mean normalized response.

FIG. 8 shows the central section of FIG. 7 at higher resolution. The outermost green rectangle encompasses those compounds with kinetics that are within ˜10 fold of the mean normalized response. The other green rectangles encompass those compounds with kinetics that are within ˜5 fold, 2 fold. 1.5 fold and 1.2 fold of the mean normalized response, respectively.

FIG. 9 shows the number of compounds interacting selectively and non-selectively, as a function of the selected range of rise and decay times of their fluorescence intensity over time.

### DETAILED DESCRIPTION OF THE PREFERRED EMBODIMENT

### Example

In this example, the method of the disclosure was used to investigate the interaction of various different chemical compounds with a G-protein coupled receptor (GPCR) heterologously expressed in a mammalian HEK-293 cell line. It was the aim of this study to identify specific agonists for the GPCR, i.e. compounds which interact specifically with the receptor under study by binding to the receptor and triggering an intracellular response via a second messenger system, but neither interact with other receptors present in the same cell line nor trigger a comparable response by another mechanism. 7680 assay wells were used in this example analysis of which 5238 were compounds, 480 controls and 1962 wells to which only a solvent (DMSO) without compound was added.

The initial screen identified 5338 compounds of further interest of which 500 were selected based on chemistry triage.

As is well known to those skilled in the art, binding of extracellular compounds to GPCRs causes an intracellular signal cascade, mediated by G proteins coupling to the receptor. Specifically, agonists acting on the GPCR under study will in a first phase trigger an increase in the intracellular level of Ca²⁺ ions. In a second phase, —through various mechanisms, including re-entry of Ca²⁺ ions in the endoplasmatic reticulum (ER)—the Ca²⁺ level in the cells under study decreases again.

It is well-known in the art to observe the intracellular level of Ca²⁺ ions via the use of fluorescent “calcium indicator” dyes. These dyes exhibit shifts in fluorescence excitation and/or emission spectra, and/or emission levels, upon binding to Ca²⁺. By introducing these dyes into the cytoplasm, and then observing fluorescence emission in a series of measurements before and during exposure of the cells to a potential agonist, the change of intracellular Ca²⁺ levels can be followed over time as a change in observed fluorescence intensity and/or wavelength.

In this study, the “Fluorescent Imaging Plate Reader” (FLIPR) as well as the NoWash Calcium Indicator Dye (Molecular Devices #R8033), both commercially available from Molecular Devices, Inc., were used to measure fluorescent intensities. In preparation for the measurements non-adherent HEK-293 cells and compounds were pre-dispensed into separate plates prior to start of assay. The screen was performed in the 384 well plate format with 360 compounds and 24 controls per plate. Compounds were transferred to the wells containing cells using the integrated pipetting device of the FLIPR, thus bringing into contact the compounds with their interaction partner. The temporal evolution of fluorescence from the Calcium Indicator Dye, while irradiated with 488 nm excitation light, was then observed and recorded using the FLIPR reader. The interaction between the compounds and their interaction partner results in a temporal sequence of measurement values comprising both a temporal phase of increasing measurement values and a temporal phase of decreasing measurement values. Time scales, addition speeds and dispense heights were pre-defined by the user in the FLIPR software.

In the prior art, the FLIPR data are typically evaluated by determining the peak height (maximum measurement value,) and/or the integrated fluorescence (area under the curve,) of the fluorescence signal. It is known in the art that no information about the specificity of the agonist's interaction with the receptor can be gained from this evaluation. Large values of integrated fluorescence and/or peak height may indicate the presence of a specific agonist. However they may also be due to an unspecific interaction either with another receptor or an entirely different mechanism which is undesirable, or due to measurement artefacts (which may indicate activity for a non-active compound). The latter notably include the presence of autofluorescent compounds, which may falsify the observed fluorescence signals. It is therefore customary in the prior art to follow the primary screen with secondary screens aiming at eliminating unspecific binders as well as invalid agonists associated with measurement artefacts. There is no indication in the prior art that the study of functional course of both the phase of increasing and decreasing measurement values, as taught by the present disclosure, can provide additional relevant information.

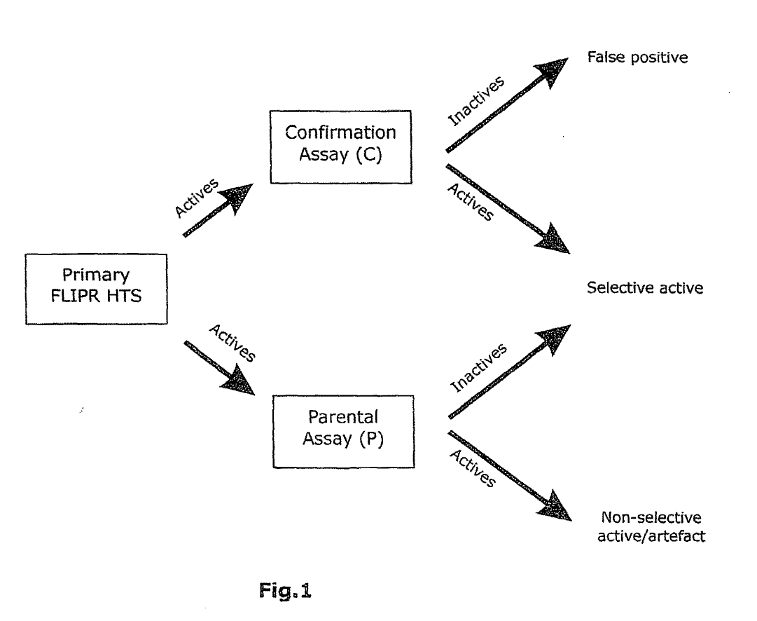

FIG. 1 shows two of the early steps of this method: All apparently active compounds are re-screened in a confirmation screen and a so-called parental screen. In the confirmation screen those compounds that have shown activity in the primary screen (hits) are re-screened under identical conditions and concentrations on the same platform. With the confirmation screen it can thus be confirmed that the hits truly show activity. In the parental screen the interaction of the hits with a cell line not exhibiting the receptor under study (a “receptor negative cell line”) is measured to exclude that a hit unspecifically interacts with multiple receptors. A response in a receptor negative cell line indicates the compound is acting at an alternative receptor or is fluorescent.

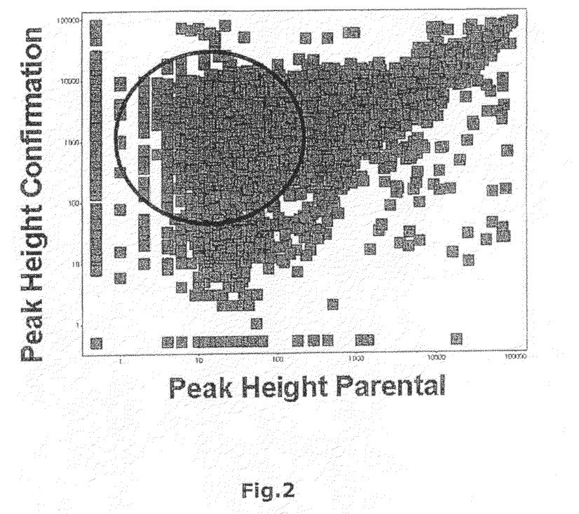

FIG. 2 illustrates the limitations of the prior art approach. In particular, it confirms that no information about specificity of interactions is available from the evaluation parameters used in the art, i.e. peak height and area under curve. FIG. 2 shows the peak heights as derived from the confirmation and parental screen. As apparent from FIG. 2, for many compounds there is a strong correlation between peak heights observed in the confirmation and parental screen—this means that most compounds observed as highly active in the confirmation (and hence also the primary) screen are actually interacting with the receptor non-specifically, and are hence of no pharmacological use. However, a substantial fraction of compounds—encompassed by the black circle—show substantial activity in the confirmation and little activity in the parental screen, indicating that they are selective. Unfortunately, when following the approach known in the art, the costly confirmation and parental screen needs to be carried out for this large number of compounds before one can distinguish between these two populations.

The confirmation and parental screen as well as the other additional validation steps collectively referred to as secondary screens involve-high labour costs as well as additional consumption of potentially expensive compounds and reagents. The method of the present disclosure therefore aims at identifying specific agonists without costly secondary screens. Nevertheless, the confirmation and parental screens are carried out in this example to demonstrate and verify the benefits of the disclosure.

According to the disclosure, new evaluation parameters can be derived from the observed time sequence of fluorescence intensity data, which allow to predict the specificity of agonist interaction directly from the primary screen's results. To this end, a mathematical model which contains one first parameter characterising a temporal phase of increasing fluorescence intensity values and at least one second parameter characterising a temporal phase of decreasing fluorescence intensity values is fitted to each temporal sequence of fluorescence intensity values. Specifically, the model chosen here fits the temporal sequence in two separate segments: A single Gaussian function,

f₀(t)=a₀*exp [(t−t₀)²/s₀²] |t<t₀

is fitted to the segment showing increasing fluorescence intensity values, and a superposition of two Gaussian functions,

f₁(t)=a₁*exp [(t−t₀)²/s₁²]+(a₀−a₁)*exp [(t−t₀)²/s₂²] |t>t₀

is fitted to the segment showing decreasing fluorescence intensity values. Here, t₀ denotes the time when the maximum fluorescence intensity is observed, a₀ denotes the maximum fluorescence intensity value, and s₀, s₁ and s₂ denote typical rise and decay times, respectively. By convention, s₁ is used to denote the faster of the two decay components, i.e. s₁<s₂. An additive term accounting for basal fluorescence has been omitted for clarity.

FIG. 3 shows three example flourescent intensity traces that have been elicited by three different compounds (Color 1 line). Superimposed are fit results (Color2 line) where the fluorescent signals have been fitted according to the model outlined above. The first example (left panel) shows the response to the maximum control compound. A compound that after a series of validation screens has eventually been selected as a compound attractive for medicinal chemists has induced the second fluorescent intensity traces (middle panel). The third response (right panel) stems from a compound known to give rise to a false positive hit because it is autofluorescent. These three examples serve to illustrate two elements that are central to the method of the disclosure i) the mathematical model fits the rise and decay times of the compound elicited responses and ii) the quality of how well the model describes the raw data—which can mathematically be described with a χ² (Chi2) value—differs between different compounds. The benefits of using these elements for data analysis is outlined below.

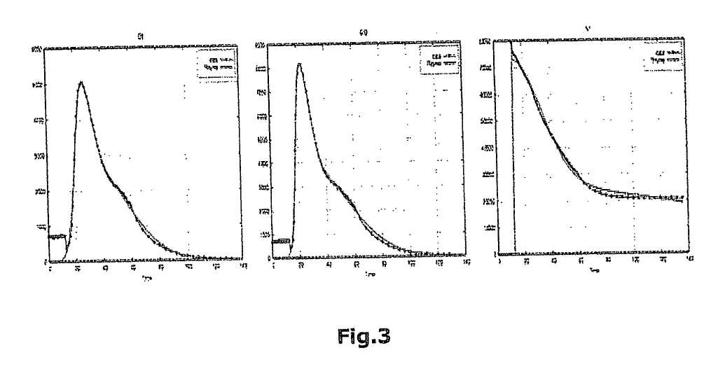

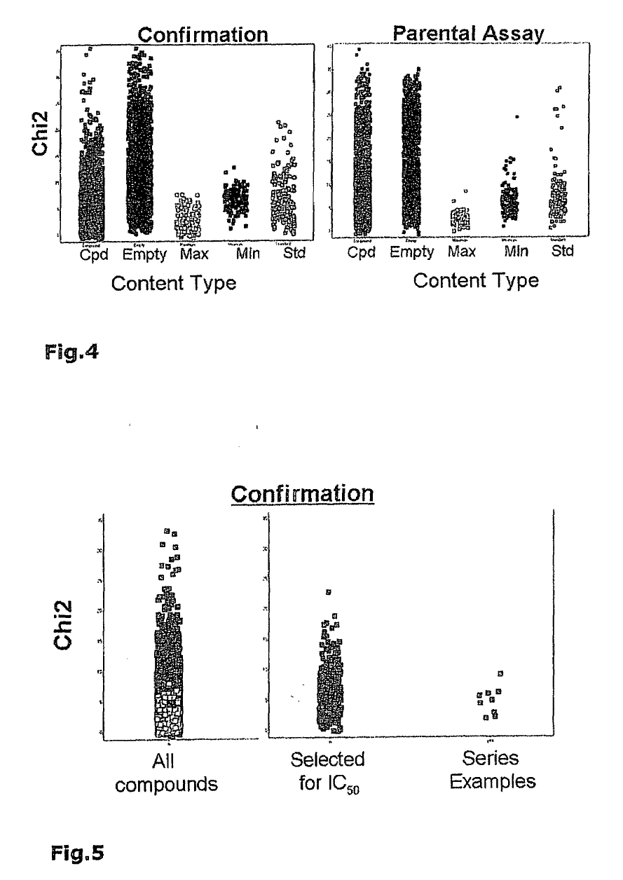

Although the observed data sets stem from complex cellular responses, they are fit quite well by the functional model. FIG. 4 shows χ² (Chi2) values for all compounds under investigation, as well as for a number of control samples, i.e. substances known to induce in the cells a minimal response, a maximal response and a “standard” response (defined here as 50% of the maximum response). The standard definition for the χ² value in mathematical statistics is used, i.e. essentially a normalized mean square deviation between functional model and actual measurement sequences. In the present statistical ensemble, a χ² value of less than 5, as observed for all maximum and standard controls, indicates very good agreement between functional model and measurement sequences. As expected, higher χ² values are observed for the minimum control samples, which exhibit generally weak fluorescence signals, and for some of the actual compounds under investigation, which are associated with artefacts including autofluorescence. It is worth pointing out that for the compounds (shown in red) there are more fits with low χ² values for the confirmation screen than for the parental screen.

Since the costs of the various secondary screens are considerable it is quite common not to advance all compounds that have shown to be selective from one screen to the next. Instead a fraction of the selective compounds are chosen according to a variety of criteria including but not limited to physicochemical properties that are thought to be indicative of the likelihood that a compound can be modified to become a drug. In this endeavour it is very helpful in case compound series with similar structure but variable side chains can be identified that prove to be selective. FIG. 5 shows χ² values for all compounds as derived from the fits to the responses they elicited in the confirmation screen. The middle and right column show the χ² values of those compounds that were later selected for a validation screen (IC50 determination) and example compounds from eight different compound series. This illustrates that the behaviour of those compounds that prove chemically attractive are described and fit very well by the mathematical model. In other words, based on the quality of the fit (as indicated by a low χ²) of the model to primary screen data one can select a pool of compounds that are attractive for further optimization by medicinal chemists thus avoiding some of the time and cost intensive secondary screens.

Based on the described mathematical model it is possible to describe all or parts of the temporal sequence with a different kinds of parameters such as for example the rise and decay times. Two such parameters that have been used in the present study presented include the ‘Normalised Width Ascending’ and the ‘Normalised Width Descending’ which in this particular case have been calculated as follows. The median value of all fit results were calculated for the 12 High Control wells on each plate. The normalised fit results for a well were defined as the response of the well divided by the median response of the corresponding High Control wells on the same plate. Therefore, the ‘Normalised Width Ascending’ of a well is the width ascending fit result for that well, divided by the median width ascending of the High Control wells on that plate. Similarly, ‘Normalised Width Descending’ of a well is the width descending fit result for that well, divided by the median width descending of the High Control wells on that plate.

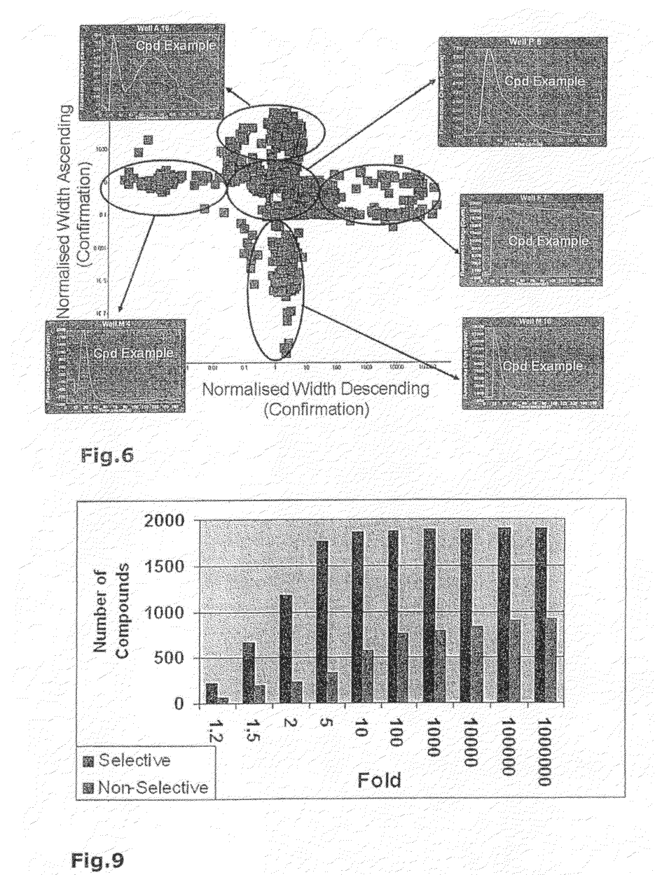

Following the method of the disclosure, we now investigate the fit parameters Normalized Width Ascending (NWA) and Normalized Width Descending (NWD) determined above. FIG. 6 illustrates the wide distribution of NWA and NWD for the compounds under investigation. The upper right inset shows an example of a compound inducing a response with rise and decay kinetics very similar to the maximum controls (shown in yellow). The other insets provide examples of a compounds inducing various combinations of similar, shortened and prolonged rise and decay times. Most notably, extended decay times and shortened rise times are often observed. Since these extended or shortened times are not observed in the control samples which are known to be specific agonists, it can be hypothesized that they are due to measurement artefacts and/or unspecific interactions exhibiting different kinetic behaviour. Following this hypothesis, we select only those compounds under investigation associated with fluorescence rise and decay times in the range observed for the control samples (indicated by the central black ellipse in FIG. 6).

With the next three figures we show how two fit parameters of the method of the disclosure (NWA and NWD) can be used to chose selective compounds from the primary screen in a quantitative manner. This is illustrated by using data from the confirmation and parental screens. In the method used in the state of the art these secondary screens are performed tp allow one to distinguish between selective and non-selective compounds.

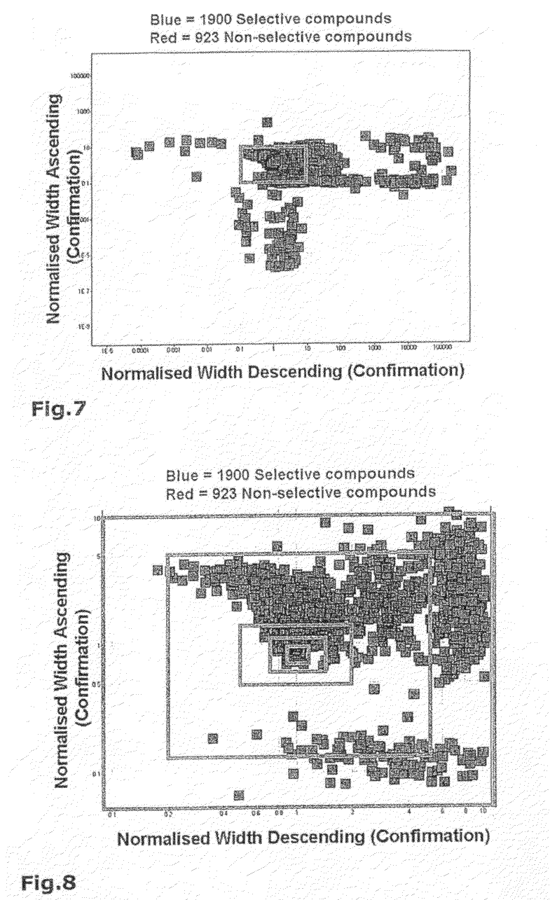

FIG. 7 shows the NWA plotted against the NWD obtained from fits to compound induced responses of the confirmation screen. Depicted in blue are those compounds that have shown to be active in the confirmation and non-active in the parental screen. They are thus classified as selective. The red labelled compounds are the non-selective ones since they have shown activity in the confirmation and the parental screen. Interestingly, 1880 out of the 1900 (98.9%) of the selective compounds have kinetics within 10-fold of the normalized response shown by the maximum control that is illustrated by the green rectangle. The fraction of non-selective compounds within in this area is much lower. This is better illustrated in FIG. 8, which shows the same plot as FIG. 7 at higher magnification. The outermost green rectangle encompasses the same area as the green rectangle in FIG. 7. The inner green rectangles encompass those compounds with kinetics that are within ˜5 fold, 2 fold. 1.5 fold and 1.2 fold of the mean normalized response of the maximum control, respectively. By closing in onto the mean response exhibited by the maximum controls, one gets the impression that the ratio of selective over non-selective compounds increases. This has been further quantified in FIG. 9 which shows the number of selective (red) and non-selective (blue) compounds within the areas that are 1.2 to 1000000 fold of the normalized response shown by the maximum control. In this example the biggest enrichment for selective over non-selective compounds (5.4 to 1) takes place for responses that are within five fold of the standard response.

In summary, FIGS. 7 to 9 illustrate one example of a strategy to enrich selective over non-selective compounds at a very early screening stage by using both the kinetics of the rising and the decay phase. However one could also think of alternative strategies. One such strategy could for example be to look for compounds that have an up to five fold increased NWA and a NWD ranging from five fold decreased to two fold increased. All such strategies have in common that fitting the rise and decay times of a compound elicited response enables the comparison to kinetics displayed for the maximum control compound and the prediction of whether the compound under investigation is likely to be selective or non-selective. In summary this example therefore shows that, by characterising the interaction between a compound and a receptor according to the rise and decay times of the observed time sequence of measured fluorescence intensities, valuable information towards the validity and specificity of the interaction can be gained, without the need for costly secondary screens.

1. A method for detecting a biochemical interaction between at least two interaction partners, comprising the steps of
bringing into contact the at least two interaction partners,
taking a temporal sequence of measurements, each of them producing a measurement value describing the state of the interaction at a given point in time,
choosing a mathematical model to describe the temporal sequence of measurements, whereby the model comprises at least one first parameter characterising a temporal phase of increasing measurement values and at least one second parameter characterising a temporal phase of decreasing measurement values,
adapting the mathematical model to the temporal sequence of measurements, whereby values for said parameters are determined which result in a good approximation of the temporal sequence of measurements by the mathematical model, and
detecting the biochemical interaction by evaluating the values of the first and second parameter and/or a measure of deviation of the mathematical model from the temporal sequence of measurements.

2. Method according to claim 1, whereby the temporal sequence of measurement values comprises a temporal phase of increasing measurement values and/or a temporal phase of decreasing measurement values.

3. Method according to claim 1, whereby the at least one first parameter characterises a rise time or rise rate corresponding to the temporal phase of increasing measurement values, and whereby the at least one second parameter characterises a decay time or decay rate corresponding to the temporal phase of decreasing measurement values.

4. Method according to claim 1, whereby the mathematical model uses separate functions to describe the phases of increasing and decreasing measurement values of the sequence of measurements.

5. Method according to claim 1, whereby two mathematical models are used to describe the phase of decreasing measurement values of the sequence of measurements.

6. Method according to claim 1, whereby the mathematical model uses sections of single Gaussian functions or a superposition of sections of multiple Gaussian functions to describe the phase of increasing measurement values and the phase of decreasing measurement values.

7. Method according to claim 1, whereby the mathematical model is adapted via numerical least squares fit.

8. Method according to claim 1, whereby at least one interaction partner is a biochemical receptor, an ion channel or an ion pore.

9. Method according to claim 1, whereby at least one interaction partner is a G-protein Coupled Receptor.

10. Method according to claim 1, whereby at least one interaction partner is located in or on a cell, vesicle, organic tissue, carrier particle or a carrier surface.

11. Method according to claim 1, whereby at least one interaction partner is dissolved or suspended in a liquid.

12. Method according to claim 1, whereby the interaction of a first interaction partner with a multitude of second interaction partners is investigated in a multitude of experiments, each experiment comprising the steps of
bringing into contact the at least two interaction partners,
taking a temporal sequence of measurements, each of them producing a measurement value describing the state of the interaction at a given point in time,
choosing a mathematical model to describe the temporal sequence of measurements, whereby the model comprises at least one first parameter characterising a temporal phase of increasing measurement values and at least one second parameter characterising a temporal phase of decreasing measurement values,
adapting the mathematical model to the temporal sequence of measurements, whereby values for said parameters are determined which result in a good approximation of the temporal sequence of measurements by the mathematical model,
and thereafter using statistical analysis of the resulting multitude of values of said parameters and/or measures of deviation of the mathematical model from the temporal sequence of measurements in detecting the multitude of biochemical interactions.

13. Method according to claim 1, whereby a starting point of a temporal evolution of the biochemical interaction is defined by bringing the interaction partners into contact, and whereby preferably the bringing into contact results in a temporal sequence of measurement values comprising both a temporal phase of increasing measurement values and a temporal phase of decreasing measurement values.

14. Method according to claim 1, whereby a starting point of a temporal evolution of the biochemical interaction is defined by a first external triggering event, after the interaction partners have been brought into contact, and whereby preferably the first external triggering event results in a temporal sequence of measurement values comprising both a temporal phase of increasing measurement values and a temporal phase of decreasing measurement values.

15. Method according to claim 1, whereby a change in a direction of a temporal evolution of measurement values is defined by a second external triggering event, wherein said change comprises a transition from a phase of increasing to a phase of decreasing measurement values, or vice versa.

16. Method according to claim 1, whereby luminescence signals, preferably fluorescent signals, are measured to produce measurement values describing the state of the interaction.

17. Method according to claim 1, wherein the interaction between the at least two interaction partners results in a change of a fluorescent signal from a fluorescent reporter, where the fluorescent reporter is a potential sensitive dye, an ion sensitive dye or a pH sensitive dye.

18. Method according to claim 1, wherein one interaction partner is an ion channel and the other interaction partner is a test compound.

19. Method according to claim 18, wherein the interaction of said ion channel and said test compound results in an influx or efflux of ions, preferably calcium ions, through said ion channel, which influx or efflux preferably results in a change of a fluorescent signal from a fluorescent reporter, said reporter preferably being an ion sensitive dye.

20. Method according to claim 1, whereby the step of detecting the biochemical interaction by evaluating the values of the first and second parameter and/or the measure of deviation of the mathematical model from the temporal sequence of measurements provides information on the specificity of the interaction.

21. Method according to claim 1, whereby the step of detecting the biochemical interaction by evaluating the values of the first and second parameter provides information on the effect of measurement artefacts on the measurement values.

22. Method according to claim 1, wherein determining the measure of deviation of the mathematical model from the temporal sequence of measurements comprises the following steps:
for a multitude of measurement values selected from the temporal sequence of measurements, calculating the difference between each measurement value and the corresponding value of the mathematical model, wherein the at least one first and second parameter determined by adapting said model to said sequence of measurements are used in the model,
calculating the squares of said differences,
calculating a weighted sum of said squares, wherein the weight for each square preferably depends on the corresponding measurement value or value of the mathematical model.
